(19) United States
(12) Patent Application Publication
(10) Pub. No.: US 2007/0221549 A1
(43) Pub. Date: Sep. 27, 2007

(54) Wind-selecting and sorting facility of garbage

(76) Inventor: Chin-Hui Liu, Taiping City (TW)

Correspondence Address: TROXELL LAW OFFICE PLLC, SUITE 1404, 5205 LEESBURG PIKE, FALLS CHURCH, VA, 22041, US

(21) Appl. No.: 11/385,886

(22) Filed: Mar. 22, 2006

(51) Int. Cl. B07B 4/00; B07C 5/00; B07B 7/00

(52) U.S. Cl. 209/644; 209/930; 209/136

(57) ABSTRACT

One type of wind-selecting sorting facility of garbage which is comprised by recycle bin, blower and conveying device; wherein recycle bin is divided into fixing cylinder and rotating cylinder, front of rotating cylinder is fixed lower and rear of fixing cylinder is fixed higher, fixing cylinder is set feed hopper at its top, which produce coaxial combination with bearing and rotating cylinder, tooth at middle section of rotating cylinder can joggle with chain driven by motor; several vanes extending toward center are fixed inside rotating cylinder, and let suspend section of vane extend into fixing cylinder; wind outlet of blower aims at inner of recycle bin, baffle of gap slot at lower edge just cover top of rotating cylinder, and conveying device for sorting and collecting garbage is respectively fixed at front lower end and rear higher end of recycle bin; garbage feed into recycle bin from feed hopper, vanes stir completely garbage by rotation of rotating cylinder so as to scrape bits, powder or light garbage adhering surface of garbage, then blower blows them out from rear outlet of fixing cylinder, conveying device then conveys them for collection; block-shaped garbage (heavy material) that cannot be blown out may drop off from lower end of recycle bin, another set of conveying device collect them. Therefore, garbage can be selected and sorted by wind.

### BACKGROUND OF THE INVENTION

1) Field of Invention

This invention relates to wind-selecting and sorting facility of garbage, which is composed of one rotating cylinder with over two vanes inside and one recycle bin connecting with shaft and fixing cylinder. Garbage and its adhesive wastes are separated and then become tiny bits, powder or light garbage due to van's complete mixing, slanting set recycle bin and its partial rotation, then blower blows them into recycle bin and send out from its rear and convey toward collection zone with conveying device. As to the heavy garbage that cannot be blown out by blower may be conveyed toward another collection zone by slanting set recycle bin, so that garbage can be sieved and selected by wind.

2) Description of the Prior Art

In the past, garbage was often divided into combustible and non-combustible, however, it has been further sorted into paper, glass, metal, plastic wastes, cooking remains and non-recyclable garbage with kinds of capabilities at present. Generally speaking, vessel (or box) must be prepared for such recycle, this sorting method can recycle and reuse garbage effectively but vessel may occupy room and result in dirty. In addition, the non-recyclable garbage such as small stone (or brick, tile), branch of tree which must be sorted and collected first due to different capabilities before disposing; however, it is often difficult to confirm garbage adhering other materials on surface, such as stone or brick and tile. In order to improve the inconvenience of above said sorting of garbage, the applicant developed this facility basing on years' experience.

### SUMMARY OF THE INVENTION

This invention is to provide wind-selecting and sorting facility of garbage, which is composed of one rotating cylinder with over two vanes inside and one recycle bin connecting with shaft and fixing cylinder. Garbage and its adhesive wastes are separated and then become tiny bits, powder or light garbage due to vane's complete mixing, slanting set recycle bin and its partial rotation, then blower blows them into recycle bin and send out from its rear and convey towards collection zone with conveying device. As to the heavy garbage that cannot be blown out by blower may be conveyed toward another collection zone owing to slanting set recycle bin, so that garbage can be sieved and selected by wind.

Secondly, this invention is to apply motor and chain to drive recycle bin to rotate slowly, so that the collected garbage can be dispersed completely and stirred by vane, garbage is therefore effectively sieved.

Thirdly, this invention is to install recycle bin in proper angle so that garbage in it can slide downward.

Fourthly, basing on gap slot of baffle in the facility this invention provided, the heavy garbage sliding downward can drop off regularly from this gap slot.

### BRIEF DESCRIPTION OF THE DRAWINGS

FIG. 1 is the exploded combination view of this invention.

FIG. 2 is the detailed drawing of side view of this invention.

FIG. 3 is the application sketch map of this invention when feeding.

FIG. 4 is the application sketch map of this invention when sorting.

### DETAILED DESCRIPTION OF THE PREFERRED EMBODIMENTS

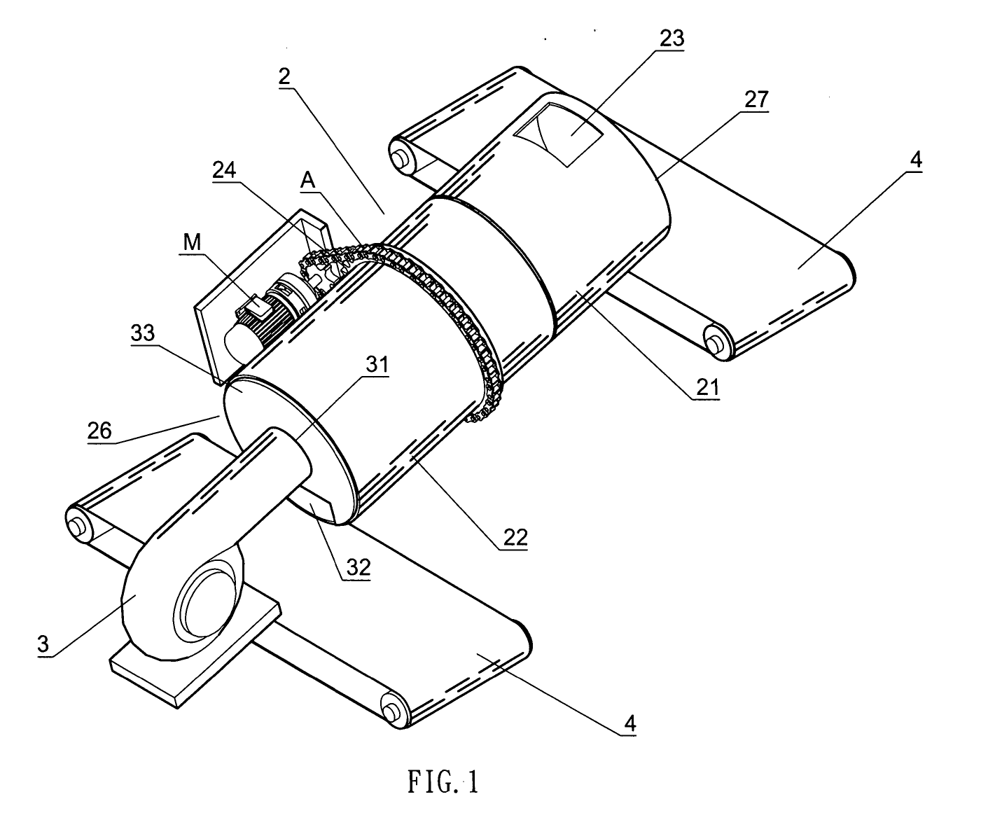

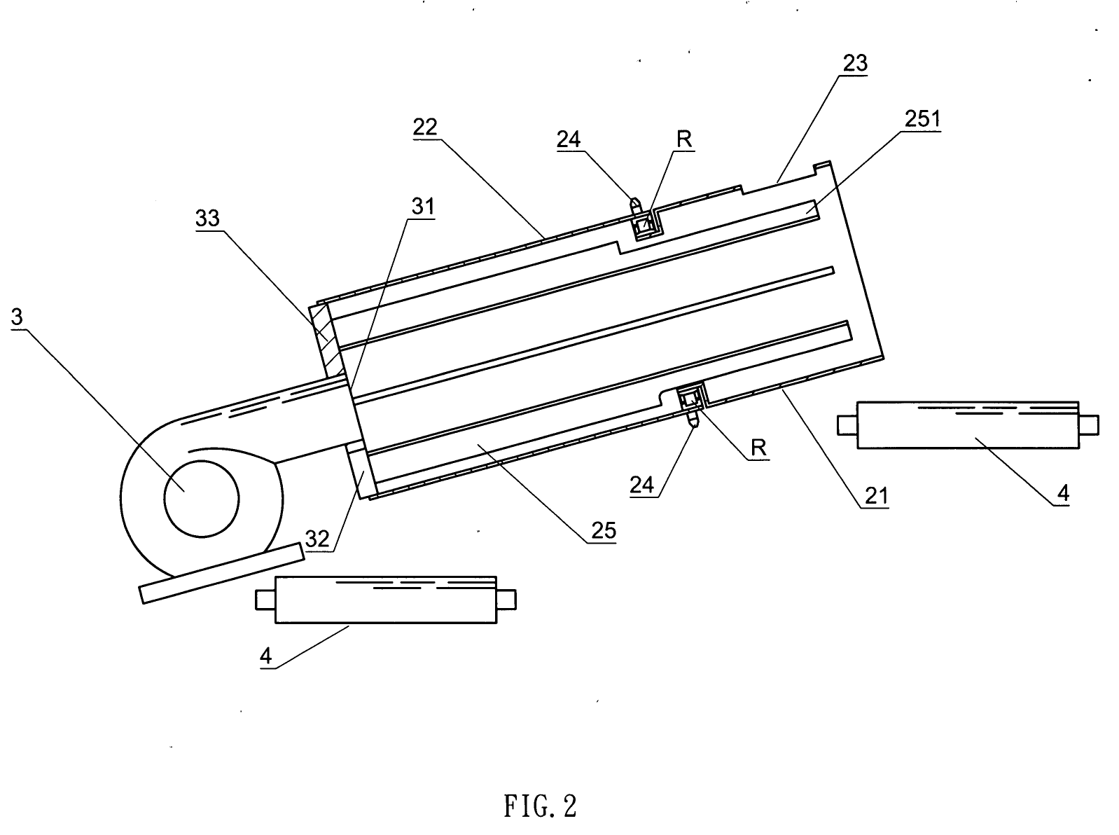

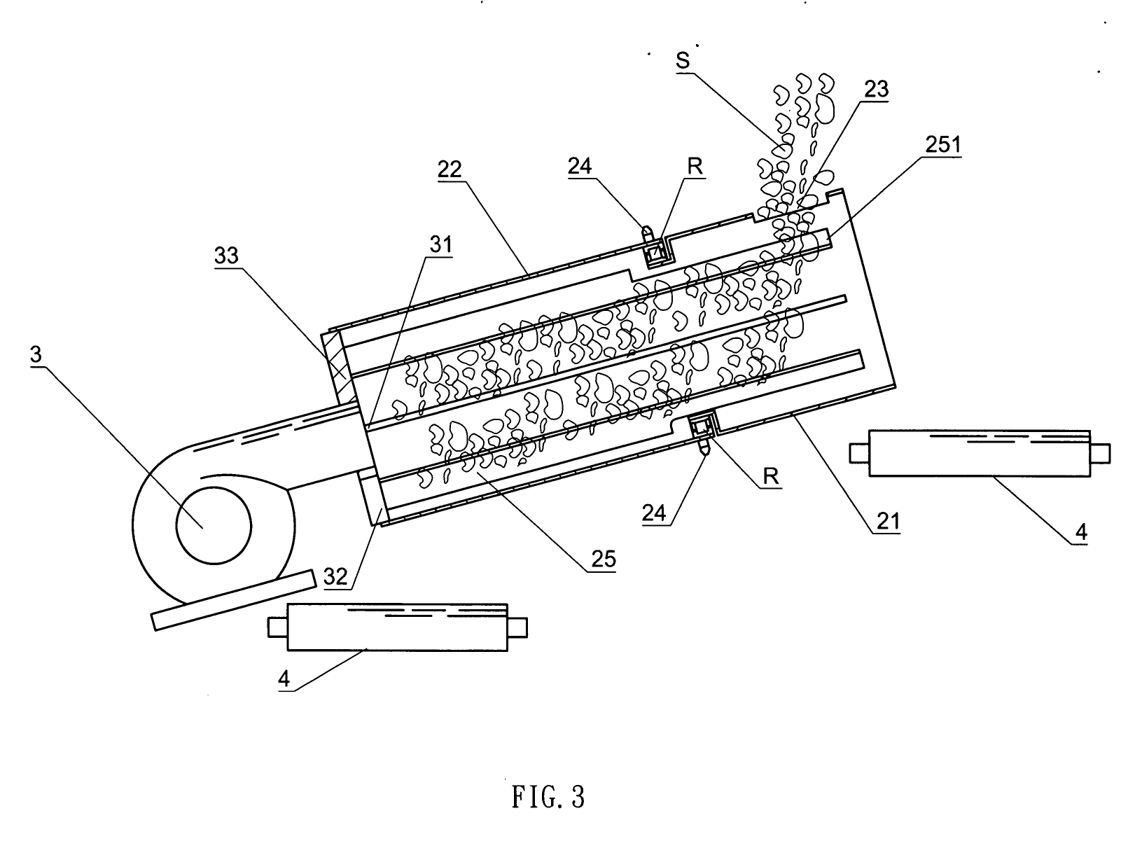

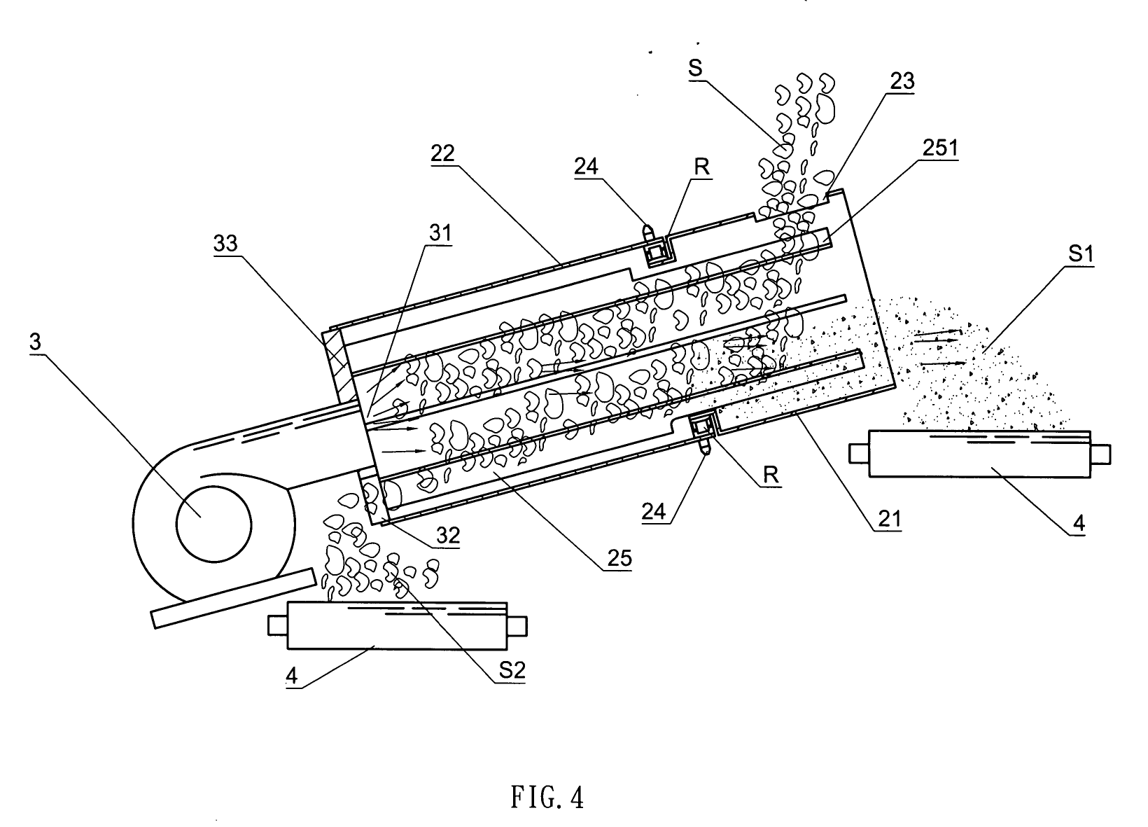

We hereby describe structure and application example of this invention with descriptions of drawings in the following, please first refer to FIG. 1, FIG. 2, FIG. 3 and FIG. 4. This invention is mainly comprised by recycle bin 2, blower 3 and conveying device 4; wherein recycle bin 2 is divided into fixing cylinder 21 and rotating cylinder 22, front of rotating cylinder 22 is fixed lower and rear of fixing cylinder 21 is fixed higher, fixing cylinder 21 is set feed hopper 23 at its top, which produce coaxial combination with bearing R and rotating cylinder 22, tooth at middle section of rotating cylinder 22 can joggle with chain A driven by motor M; several vanes 25 extending toward center are fixed inside rotating cylinder 22, and let suspend section 251 of vane 25 extend into fixing cylinder 21; wind outlet 31 of blower 3 aims at inner of recycle bin 2, baffle 33 of gap slot 32 at lower edge just cover top of rotating cylinder 22, and conveying device 4 for sorting and collecting garbage is respectively fixed at front lower end 26 and rear higher end 27 of recycle bin 2 (relation between devices are as shown as FIG. 1 and FIG. 2); garbage S feed into recycle bin 2 from feed hopper 23, vanes 25 stir completely garbage S by rotation of rotating cylinder 22 so as to scrape bits, powder or light garbage S1 adhering garbage S, then blower 3 blows them out from rear outlet 221 of fixing cylinder 21, conveying device 4 then convey them for collection; block-shaped garbage S2 (heavy material) that cannot be blown out may drop off from lower end 26 of recycle bin 2, another set of conveying device 4 collect them. Therefore, garbage can be selected and sorted by wind.

What is claimed is:

1. One type of wind-selecting and sorting facility of garbage which is comprised by recycle bin, blower and conveying device; wherein recycle bin is divided into fixing cylinder and rotating cylinder, front of rotating cylinder is fixed lower and rear of fixing cylinder is fixed higher, fixing cylinder is set feed hopper at its top, which produce coaxial combination with bearing and rotating cylinder, tooth at middle section of rotating cylinder can joggle with chain driven by motor; several vanes extending toward center are fixed inside rotating cylinder and let suspend section of vane extend into fixing cylinder; wind outlet of blower aims at inner of recycle bin, baffle of gap slot at lower edge just cover top of rotating cylinder, and conveying device for sorting and collecting garbage is respectively fixed at front lower end and rear higher end of recycle bin which can sieve and sort garbage by wind.

2. As claimed in claim 1, it is wind-selecting and sorting facility for garbage, wherein driving tooth rings middle section of rotating cylinder, motor drives it with chain so that garbage contained in recycle bin can be stirred by rotation of the rotating cylinder.

3. As claimed in claim 1, it is wind-selecting and sorting facility of garbage, wherein recycle bin of this invention is better assembled below obliquity of 35 degree.
